(19) United States
(12) Patent Application Publication
(10) Pub. No.: US 2015/0302468 A1
(43) Pub. Date: Oct. 22, 2015

(54) TARGET ADVERTISEMENT DELIVERY SYSTEM, TARGET ADVERTISEMENT DELIVERY METHOD IN SAID SYSTEM, AND TARGET ADVERTISEMENT DELIVERY PROGRAM

(71) Applicant: GREE, INC., Tokyo (JP)

(72) Inventor: Satoshi Tanaka, Tokyo (JP)

(73) Assignee: GREE, INC., Tokyo (JP)

(21) Appl. No.: 14/418,239

(22) PCT Filed: Aug. 1, 2013
(86) PCT No.: PCT/JP13/70926

§ 371 Date: Jun. 8, 2015

(30) Foreign Application Priority Data
Aug. 2, 2012 (JP) 2012-172237

(51) Int. Cl. G06Q 30/02

(52) U.S. Cl. CPC G06Q 30/0251

(57) ABSTRACT

A system that obtains first attribute information stored in a local storage of a terminal in response to receiving an advertisement delivery request; determines identification information of an advertisement based on the first attribute information; and sends the identification information of the advertisement to the terminal

### TECHNICAL FIELD

The present invention relates to a target advertisement distribution system, a target advertisement distribution method in the system, and a target advertisement distribution program.

### BACKGROUND ART

With the advancement of Internet technologies in recent years, a technology for posting an advertisement on a web screen of the Internet, a so-called ad technology has been developed. As one example of such an ad technology, a system in which an advertisement distribution server provides an effective target advertisement to a user on a web screen in response to attribute information or behavior of the user in a certain domain has been disclosed (Patent Document 1).

### PRIOR ART DOCUMENTS

### Patent Documents

Patent Document 1: Japanese Laid-Open Patent Publication No. 2010-44303

### SUMMARY OF THE INVENTION

### Problems that the Invention is to Solve

The conventional target advertisement distribution system distributes the target advertisement in response to the attribute information or the behavior of the user in a certain domain. However, the system does not distribute the target advertisement by utilizing user attribute information stored in a client terminal.

In a case where the user attribute information is stored in the client terminal, there is a method called web storage. This web storage is simple Key-Value type storage, which is divided into “local storage” and “session storage.”

The “session storage” is storage effective for a session for each window. While a window or a tab is open, data related to utilization of web applications is stored in respective units, and when the window/tab is closed, the data is lost. The session storage differs for the windows/tabs and cannot be shared.

The “local storage” is storage to persistently store data in a browser of a user of the web applications. The storage is implemented in the unit of “origin,” which is a combination of “domain: port number” as in “http:///WWW.abcdefg.co.jp:80/.” When the origin is the same, the data can be shared between the windows or the tabs, and the data can also be shared even when the browser is closed once and accessed again.

In the conventional advertisement distribution system, it is not possible to perform an effective targeting advertisement by effectively utilizing the “local storage” so as not to depend only on the user attribute information specific to a particular domain but to utilize the user attribute information in various domains.

Accordingly, it is an objective of the present invention to provide a target advertisement distribution system capable of effectively utilizing user attribute information stored in a “local storage” and performing advertisement distribution, a target advertisement distribution method in the system, a target advertisement distribution program, and information recording medium in which the program is recorded.

### Means for Solving the Problems

In accordance with the first invention of the present disclosure, a target advertisement distribution system is provided that includes: a means that, when receiving first attribute information related to identification information of a user of a terminal and an advertisement distribution request from a server related to a web page of a predetermined domain accessed by the terminal, retrieves second attribute information stored in a local storage of the terminal; a means that, when receiving the first attribute information and the advertisement distribution request from the terminal, determines identification information of an advertisement based on the received first attribute information and the retrieved second attribute information; and a means that sends the determined identification information of the advertisement to the terminal.

In accordance with the second invention of the present disclosure, a target advertisement distribution system is provided that includes: a means that, when receiving an advertisement distribution request sent from a terminal, retrieves first attribute information stored in a local storage of the terminal; a means that determines identification information of an advertisement based on the retrieved first attribute information; and a means that sends the determined identification information of the advertisement to the terminal.

In accordance with the third invention of the present disclosure, a target advertisement distribution system is provided that includes: a means that, when receiving first attribute information related to identification information of a user of a terminal and an advertisement distribution request from a server related to a web page of a predetermined domain accessed by the terminal or when receiving only an advertisement distribution request from the terminal, retrieves second attribute information stored in a local storage of the terminal; and a means that when receiving the first attribute information and the advertisement distribution request from the terminal, determines identification information of an advertisement based on the received first attribute information and the retrieved second attribute information, and when receiving only the advertisement distribution request from the terminal, determines the identification information of the advertisement based on the retrieved second attribute information. The system further includes a means that sends the determined identification information of the advertisement to the terminal.

### Effects of the Invention

The present invention provides a target advertisement distribution system capable of effectively utilizing user attribute information stored in a “local storage” and performing advertisement distribution, a target advertisement distribution method in the system, and a target advertisement distribution program.

### BRIEF DESCRIPTION OF THE DRAWINGS

FIG. 1 is an explanatory diagram showing a target advertisement distribution system according to one embodiment of the present invention.

FIG. 2 is an explanatory diagram showing a flowchart of an operation when a web page 3a of a domain B (with attribute information) is accessed.

FIG. 3 is an explanatory diagram showing a timing chart off the operation when the web page 3a of the domain B (with attribute information) is accessed.

FIG. 4 is an explanatory diagram showing a flowchart of an operation when a web page 2a of a domain A (without attribute information) is accessed.

FIG. 5 is an explanatory diagram showing a timing chart of the operation when the web page 2a of the domain A (without attribute information) is accessed.

### MODES FOR CARRYING OUT THE INVENTION

Hereinafter, a target advertisement distribution system according to one embodiment of the present invention will be described with reference to the drawings.

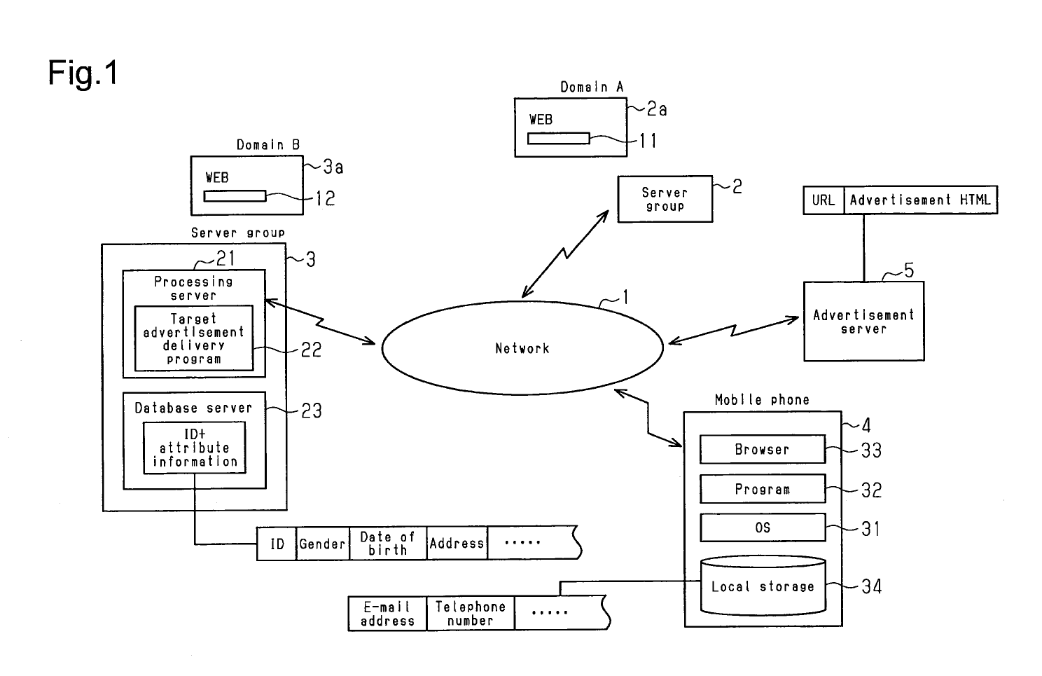

FIG. 1 is a diagram for illustrating the target advertisement distribution system according to the embodiment of the present invention.

As shown in the drawing, server groups 2, 3, a mobile phone 4, and an advertisement server 5 are connected to a network 1 such as the Internet.

The server groups 2, 3 may be realized by one computer or may be formed by a plurality of computers such as a web server, a processing server, and a database server for each of the functions thereof, and in the embodiment of the present invention, may be formed in any form. The server groups are, for example, formed by a front server group, a database server group, and a batch server group.

The front server group is in charge of shaping of execution outputs of various types of processing that can be executed upon receiving a request for communication with a client. For example, the front server group includes a web server and the like. The database server group is a processing server and database that records, for example, core processing of services provided by the server group and required data. The batch server group periodically retrieves the data from the database, performs periodic processing, and records consequent results in the database.

In the present embodiment, the server group 2 is a server group that manages a web page 2a of a domain A. A target advertisement 11 is displayed on the web page 2a. More specifically, when the mobile phone 4 accesses the web page 2a of the domain A, an advertisement distributing Java (Registered Trademark) script program that realizes part of target advertisement distribution processing according to the present embodiment embedded in the web page 2a is executed (started up) on the mobile phone 4. In the present embodiment, it is assumed that the server group 2 does not have attribute information of the user of the mobile phone 4.

The server group 3 is a server group that manages a web page 3a of a domain B, and handles part of the target advertisement distribution processing according to the embodiment of the present invention. The server group 3 is, for example, a server that handles part of the target advertisement distribution processing according to the embodiment of the present invention and manages a social networking game.

The server group 3 includes a processing server 21 and a database server 23.

The processing server 21 handles processing on the server side of the target advertisement distribution system based on a target advertisement distribution program 22 according to the present embodiment. The database server 23 stores attribute information and the like required for the advertisement distribution processing of the target advertisement distribution system.

As shown in the drawing, the attribute information (gender, date of birth, address, user level in a social networking game provided by the web page of the domain B, game points/score, and the like) is stored in the database server 23 while being related to identification information (ID) of the user.

In addition, as a method of storing this attribute information, the identification information of the user may be managed for each application program (application program ID), and the attribute information may be managed for each piece of identification information of the user.

Further, the identification information of the user may be managed for each piece of attribute information, and the application program may be managed for each piece of identification information of the user.

The “attribute information” can include information indicating the relationship with other users. For example, information such as “closeness,” “compatibility,” and “friend” with other users may serve as the attribute information.

“Closeness” is determined for each user, for example, by the number of times the user has a conversation (chat or the like) with another user. “Compatibility” is determined for each user, for example, by a character attribute, items, and the like of another user. Regarding “friend,” another user who has approved a friend request from the user or who has sent a friend request to the user, the request having been approved by the user is a “friend.” In addition, the examples described above are only one example. The attribute information is not limited to this as long as the information indicates the relationship with another user.

In addition, as other attribute information examples, the following attribute information can also be employed.

The user levels of other users of a corresponding application program, the user level to be set for each application program

Total game playing time of other users of a corresponding application program, the time to be set for each application program (for example, one day, one week, one month)

Game start time point of other users of a corresponding application program, the time point to be set for each application program (for example, the game was started in September 2012)

Game hour of other users of a corresponding application program, the hour to be set for each application program (for example, 10:00 to 14:00 on weekdays)

Charging timing of other users of a corresponding application program, the timing to be set for each application program (for example, one day, one week, one month)

Completion rate of other users of a corresponding application program, the rate to be set for each application program (for example, quest completion rate and the number of beaten boss characters)

Corresponding desired item list to be set for each application program (for example, particular SSR cards registered in a wish card list in a card game)

The number of times of posting of other users to the same message board as that of the user, the number to be set for each application program

Regional information, birthday, age, gender, hobbies, blood type, Chinese astrological zodiac sign, and profile image post of other users to be set for each application program

The number of footprints of other users who is a friend of the user, the number to be set for each application program

History information to be set for each application program such as a news article, column, and the like of other users (for example, in the fields of gourmet, shopping, beauty treatment, sports, leisure, media, entertainment, living, life, school, public service, and the like)

Ranking of other users of a corresponding application program, the ranking to be set for each application program

Game genre registration number of My Game of other users, the number to be set for each application program (for example, the registration number of two for a role-playing game). In addition, the game genre includes, for example, dating, training/simulation, board, card, sports, racing, action, timing, puzzle, adventure, education/quiz, gambling, and the like)

Avatar use rate of other users to be set for each application program

The mobile phone 4 includes a smart phone and a feature phone, and serves as a mobile phone to be operated on an operating system such as Android (Registered Trademark) and iOS (Registered Trademark), for example. In addition, although the mobile phone 4 is shown in the present embodiment, the terminal may be a computer. The computer includes a general desktop computer as well as a mobile computer, a laptop computer, and a tablet type terminal, and the like.

The mobile phone 4 has a program 32 that handles processing on the client (terminal) side of the target advertisement distribution processing according to the present embodiment operated on an operating system 31 such as Android (Registered Trademark) and iOS (Registered Trademark), a web browser program 33, and a local storage 34 of the web browser program 33. In the local storage 34, the attribute information of the user of the mobile phone 4 such as attribute information of an e-mail address, telephone number, or the like is stored as shown in the drawing.

In the advertisement server 5, a URL and advertisement HTML indicating advertisement content are stored in association with each other.

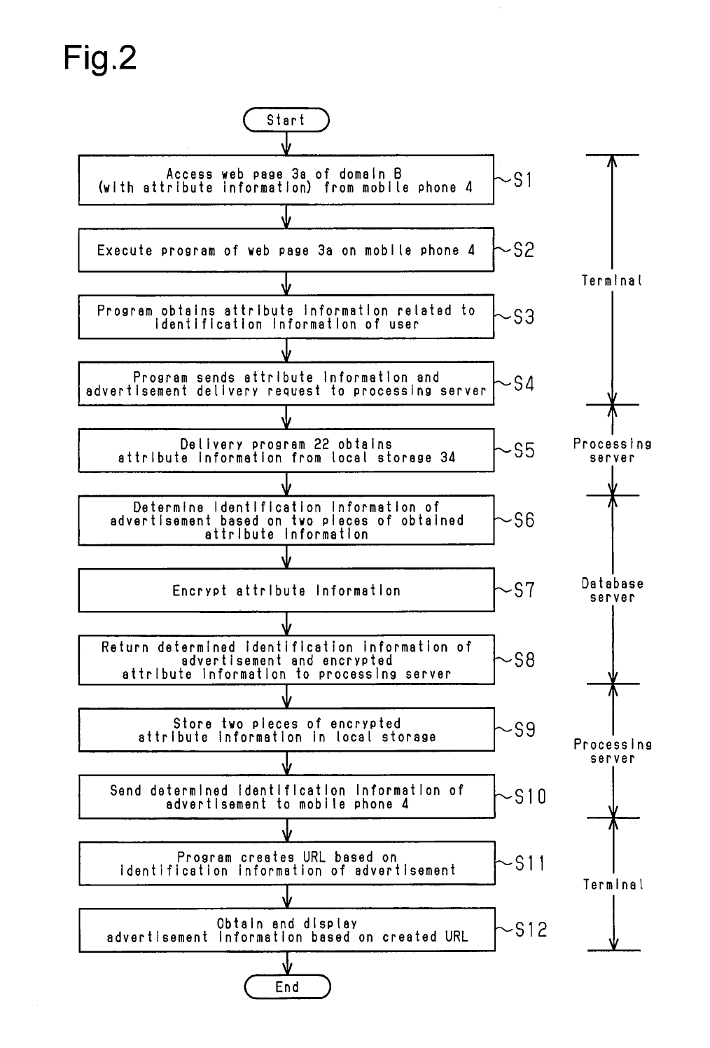

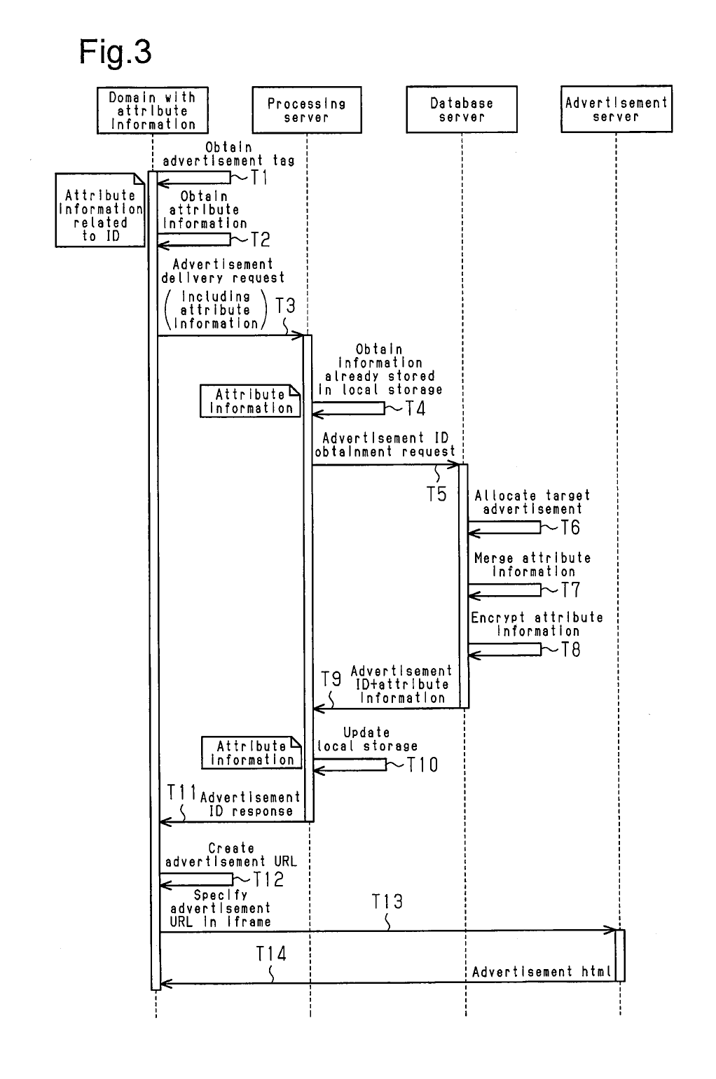

Next, operation of the target advertisement distribution system according to the embodiment of the present invention will be described. First, the operations in a case of accessing the web page 3a of the domain B (with the attribute information) will be described with reference to a flowchart of FIG. 2 and a timing chart of FIG. 3.

The user accesses the web page 3a of the domain B (with the attribute information) from the mobile phone 4 (S1, T1). An advertisement distributing program (Java script) is embedded in the web page 3a of the domain B, and the advertisement distributing program of this web page 3a is executed (started up) on the web browser program 33 of the mobile phone 4 (S2).

The advertisement distributing program of the web page 3a retrieves the attribute information (gender, date of birth, address . . . ) related to the identification information (ID) of the user from the web page 3a (database server 23) (S3). Next, the advertisement distributing program of the web page 3a sends the retrieved attribute information related to the identification information (ID) of the user and an advertisement distribution request to the processing server 21 (S4, T3).

The target advertisement distribution program 22 of the processing server 21 retrieves the attribute information from the local storage 34 of the mobile phone 4 when receiving the advertisement distribution request (S5, T4), and sends the received attribute information related to the identification information of the user and the retrieved attribute information of the local storage 34 to the database server 23 (advertisement ID retrieval request: T5).

The database server 23 determines identification information of an advertisement to be distributed based on the received attribute information related to the identification information of the user and the attribute information of the local storage 34 (decrypts in a case where the information is encrypted) (S6, T6), and merges and encrypts the received attribute information related to the identification information of the user and the attribute information of the local storage 34 (S7, T7, T8).

In a case where the attribute information includes information indicating the relationship with another user, the identification information of the advertisement can be determined also in consideration of the relationship between the user and the other user. Thus, a more appropriate advertisement can be provided to the user.

After that, the database server 23 returns the determined identification information of the advertisement, the encrypted attribute information related to the identification information of the user and the encrypted attribute information of the local storage 34 to the processing server 21 (S8, T9).

The processing server 21 stores the encrypted attribute information related to the identification information of the user and the encrypted attribute information of the local storage 34 in the local storage 34 (S9, T10). The processing server 21 sends the determined identification information of the advertisement to the mobile phone 4 (S10, T11).

The advertisement distributing program of the web page 3a of the mobile phone 4 creates a URL in which the actual advertisement HTML is placed based on the sent identification information of the advertisement (S11, T12), and, based on this created URL, retrieves advertisement information (HTML) from the advertisement server 5 and displays the advertisement information on the web page 3a (S12, T13, T14).

Therefore, according to the present embodiment, based on the attribute information related to the identification information of the user and the identification information of the local storage, the target advertisement is determined. Thus, a more efficient target advertisement can be provided.

In particular, in a case where the attribute information related to the identification information of the user includes the information indicating the relationship with another user, a more appropriate advertisement can be determined also in consideration of the relationship with the other user.

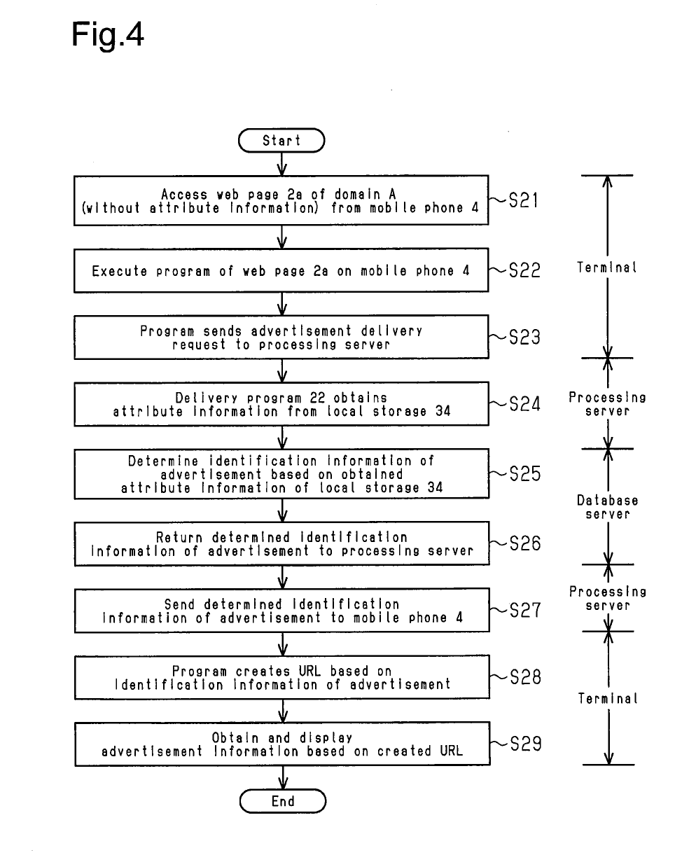

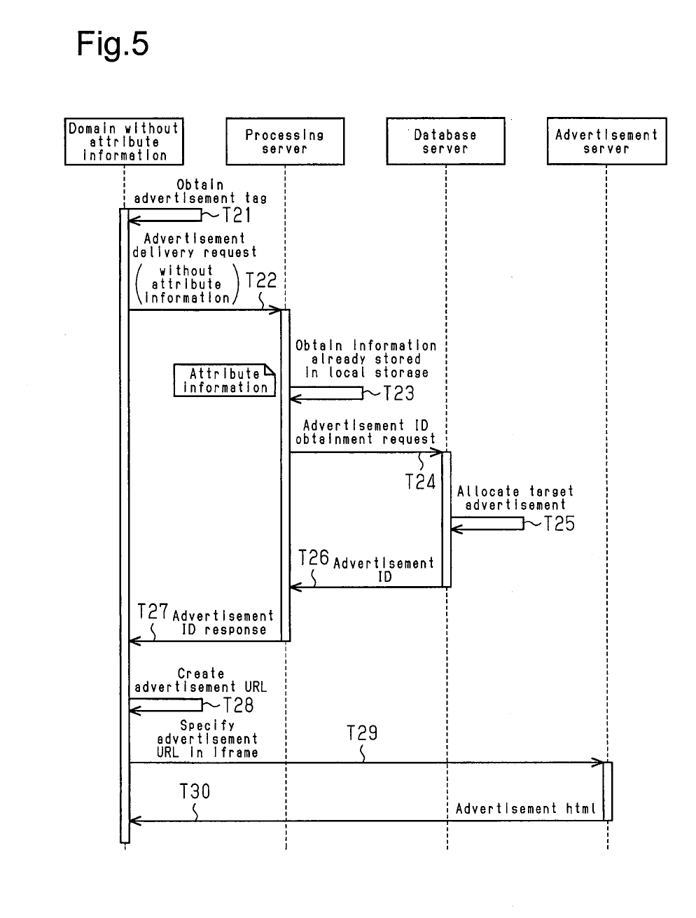

Next, operation of the advertisement distribution system in a case of accessing the web page 2a of the domain A (without the attribute information) will be described with reference to the flowchart of FIG. 4 and the timing chart of FIG. 5.

The user accesses the web page 2a of the domain A (without the attribute information) from the mobile phone 4 (S21, T21). The advertisement distributing program (Java script) is embedded in the web page 2a of the domain A, and the advertisement distributing program of this web page 2a is executed (started up) on the web browser program 33 of the mobile phone 4 (S22).

Next, the advertisement distributing program of the web page 2a sends an advertisement distribution request to the processing server 21 (S23, T22).

The target advertisement distribution program 22 of the processing server 21 retrieves the attribute information from the local storage 34 of the mobile phone 4 when receiving the advertisement distribution request (S24, T23), and sends the retrieved attribute information of the local storage 34 to the database server 23 (advertisement ID retrieval request: T24).

The database server 23 determines identification information of an advertisement to be distributed based on the attribute information of the local storage 34 (decrypts in a case where the information is encrypted) (S25, T25), and returns the determined identification information of the advertisement to the processing server 21 (S26, T26). The processing server 21 sends the identification information of the advertisement to the mobile phone 4 (S27, T27).

The advertisement distributing program of the web page 2a of the mobile phone 4 creates a URL in which the actual advertisement HTML is placed based on the sent identification information of the advertisement (S28, T28), and, based on this created URL, retrieves advertisement information (HTML) from the advertisement server 5 and displays the advertisement information on the web page 2a (S29, T29, T30).

Therefore, according to the present embodiment, even in a case of accessing the page of the domain in which no attribute information exists, an effective target advertisement is provided by utilizing the attribute information of the local storage.

In addition, the flow of the processing is described separately for the case of accessing the page of the domain in which the attribute information exists and for the case of accessing the page of the domain in which the attribute information exists in the above embodiment. However, the processing may be commonly executed for both cases by providing a means for determining whether the attribute information exists.

That is, a terminal determines whether first attribute information related to identification information of a user of the terminal exists in a server related to a web page of a predetermined domain accessed by the terminal. In a case of determining that the first attribute information exists, the terminal sends an advertisement distribution request to an advertisement distribution server together with the first attribute information. In a case of determining that no first attribute information exists, the terminal sends only the advertisement distribution request to the advertisement distribution server.

In a case where the first attribute information and the advertisement distribution request sent from the terminal, or only the advertisement distribution request sent from the terminal is received, the advertisement distribution server retrieves second attribute information stored in a local storage of the terminal. In a case where the first attribute information and the advertisement distribution request are received from the terminal, the advertisement distribution server determines the identification information of the advertisement based on the received first attribute information and the retrieved second attribute information. In a case where only the advertisement distribution request is received from the terminal, the advertisement distribution server determines the identification information of the advertisement based on the retrieved second attribute information, and sends the determined identification information of the advertisement to the terminal.

Several embodiments of the present invention have been described. However, these embodiments are provided as examples with no intention to limit the scope of the invention. These novel embodiments can be implemented in various other modes, and various omissions, replacements, and changes can be made within the range not departing from the gist of the invention. These embodiments and modifications thereof are included in the scope and the gist of the invention and included in the invention described in the claims and the range of equivalents.

Also, the method described in the embodiments can be stored in a recording medium such as a magnetic disk (floppy (Registered Trademark) disk, hard disk, and the like), an optical disc (CD-ROM, DVD, MO, and the like), and a semiconductor memory (ROM, RAM, flash memory, and the like) as a program that can be executed by a computing machine (computer), or can be transferred and distributed by a communication medium. In addition, the program to be stored on the medium side also includes a setting program for configuring a software means (including not only an execution program but also a table and a data structure) to be executed by the computing machine in the computing machine. The computing machine for realizing the device reads the program recorded in the recording medium, or constructs the software means by the setting program according to circumstances and executes the above processing by controlling operations by this software means. In addition, the recording medium described in the present specification includes not only the one for distribution but also a storage medium provided inside the computing machine or in a device connected via a network such as a magnetic disk and a semiconductor memory.

### DESCRIPTION OF THE REFERENCE NUMERALS

1 . . . Network, 2, 3 . . . Server group, 2a . . . Web page of domain A (with attribute information), 4 . . . Mobile phone, 5 . . . Advertisement server, 21 . . . Processing server, 22 . . . Target advertisement distribution program, 23 . . . Database server, 31 . . . operating system, 32 . . . Terminal side program, 33 . . . Browser, 34 . . . Local storage.

1-7. (canceled)

8. A system comprising:
circuitry configured to
obtain first attribute information stored in a local storage of a terminal in response to receiving an advertisement delivery request;
determine identification information of an advertisement based on the first attribute information; and
send the identification information of the advertisement to the terminal.

9. The system of claim 8, wherein the circuitry is configured to:
receive the advertisement delivery request in response to the terminal accessing a web page of a predetermined domain.

10. The system of claim 8, wherein
the circuitry is configured to receive second attribute information together with the advertisement delivery request, the second attribute information related to identification information of a user of the terminal.

11. The system of claim 10, wherein
the circuitry is configured obtain the first attribute information in response to receiving the second attribute information together with the advertisement delivery request.

12. The system of claim 11, wherein
the identification information of the advertisement is determined based on the first attribute information and the second attribute information.

13. The system of claim 8, wherein
the circuitry is configured to receive second attribute information together with the advertisement delivery request.

14. The system of claim 13, wherein
the circuitry is configured to determine the identification information of the advertisement based on the first attribute information and the second attribute information in response to receiving the second attribute information together with the advertisement delivery request.

15. The system of claim 13, wherein
the circuitry is configured to determine the identification information of the advertisement based on the first attribute information in response to receiving only the advertisement delivery request.

16. The system of claim 8, wherein
the system is a server.

17. The system of claim 10, wherein
the system is a server, and
the circuitry is configured to receive the second attribute information together with the advertisement delivery request from another server remotely connected to the server via a network.

18. The system of claim 8, wherein
the system comprises a plurality of servers connected via a network.

19. The system of claim 10, wherein
the system comprises at least a first server and a second server connected via a network.

20. The system of claim 19, wherein the first server is configured to:
encrypt the first and second attribute information; and
transmit the encrypted first and second attribute information to the second server via the network.

21. The system of claim 20, wherein the second server is configured to:
receive the encrypted first and second attribute information from the first server;
decrypt the first and second attribute information;
determine the identification information of the advertisement based on the decrypted first and second attribute information; and
send the identification information of the advertisement to the terminal.

22. The system of claim 8, wherein
the first attribute information comprises at least one of an email address and a telephone number.

23. The system of claim 10, wherein
the first attribute information comprises at least one of an email address and a telephone number; and
the second attribute information comprises at least one of identification information of a user of the terminal, a gender of the user of the terminal, a date of birth of the user of the terminal, and an address of the user of the terminal.

24. The system of claim 23, wherein
the second attribute information further comprises information indicating a relationship with other users of other terminals and information indicating usage of a game application of the users of the other terminals.

25. One or more non-transitory computer-readable media including computer program instructions, which when executed by a system, cause the system to:
obtain first attribute information stored in a local storage of a terminal in response to receiving an advertisement delivery request;
determine identification information of an advertisement based on the first attribute information; and
send the identification information of the advertisement to the terminal.

26. The one or more non-transitory computer-readable media of claim 25, wherein the system is further caused to:
obtain the first attribute information in response to receiving second attribute information together with the advertisement delivery request; and
determine the identification information of the advertisement based on the first attribute information and the second attribute information.

27. A method performed by an information processing system, the method comprising:
obtaining, via a communication interface, first attribute information stored in a local storage of a terminal in response to receiving an advertisement delivery request;
determine, by circuitry, identification information of an advertisement based on the first attribute information; and
send, via the communication interface, the identification information of the advertisement to the terminal
